(19) United States
(12) Patent Application Publication
(10) Pub. No.: US 2025/0310044 A1
(43) Pub. Date: Oct. 2, 2025

(54) RESOURCE ALLOCATION METHOD, APPARATUS, DEVICE AND STORAGE MEDIUM

(71) Applicant: Beijing Xiaomi Mobile Software Co., Ltd.,, Beijing (CN)

(72) Inventors: Zhenyu ZHANG, Beijing (CN); Wei HONG, Beijing (CN); Yumin WU, Beijing (CN)

(21) Appl. No.: 18/863,960

(22) PCT Filed: May 12, 2022
(86) PCT No.: PCT/CN2022/092560

§ 371 Date: Nov. 7, 2024

(51) Int. Cl. H04L 5/00; H04L 1/00; H04W 72/0453

(52) U.S. Cl. CPC H04L 5/003; H04L 1/0071; H04L 5/0007; H04W 72/0453

(57) ABSTRACT

The present disclosure belongs to the technical field of communications. Provided are a resource allocation method/apparatuses/device/storage medium. The method comprises: determining a resource allocation scheme as follows: performing resource allocation on the basis of a 4-PP interleaver; allocating resources by using the resource allocation scheme; and sending indication information, wherein the indication information is used for determining the allocated resources. The method provided in the present disclosure ensures the detection effect on a data receiving end, improves the detection performance of a sensing and communication system, and facilitates the detection of a moving target in the sensing and communication system.

### CROSS REFERENCE TO RELATED APPLICATION

The present application is a U.S. National Stage of International Application No. PCT/CN2022/092560, filed on May 12, 2022, the content of which is incorporated by reference herein in its entirety.

### TECHNICAL FIELD

The present disclosure relates to the field of communication technology, and in particular to resource allocation method, device, apparatus and storage medium.

### BACKGROUND

With the combination of millimeter wave technology and large-scale multi-input multi-output technology, the communication system and the sensing system have certain similarities in hardware architecture, channel characteristics, signal processing, etc. Therefore, the integrated sensing and communications (ISAC) can be realized by sharing spectrum resources, hardware resources and signaling resources between the communication system and the sensing system, that is, the combination of radar and communication systems to obtain the integration gain of ISAC.

### SUMMARY

The present disclosure proposes resource allocation method, device, apparatus and storage medium to solve the problem in the related art that the resource allocation method affects the detection effect of the data receiving terminal.

According to an aspect of the present disclosure, there is provided a resource allocation method, including:
determining a resource allocation scheme as performing resource allocation based on a Quartic Permutation Polynomial (4-PP) interleaver;
allocating a resource based on the resource allocation scheme; and
sending indication information, where the indication information is configured to determine an allocated resource.

According to another aspect of the embodiments of the present disclosure, there is provided a data sending device, including:
a determining module for determining a resource allocation scheme as performing resource allocation based on a 4-PP interleaver;
an allocating module for allocating a resource based on the resource allocation scheme; and
a sending module for sending indication information, wherein the indication information is configured to determine an allocated resource.

According to another aspect of the embodiments of the present disclosure, there is provided a data receiving device, including:
a determining module for determining a resource allocation scheme as performing resource allocation based on a 4-PP interleaver;
an allocating module for allocating a resource based on the resource allocation scheme; and
a sending module for sending indication information, where the indication information is configured to determine an allocated resource.

According to another aspect of the embodiments of the present disclosure, there is provided an echo receiving device, including:
a determining module for determining the resource allocation scheme as performing resource allocation based on a 4-PP interleaver;
an allocating module for allocating a resource based on the resource allocation scheme; and
a sending module for sending indication information, where the indication information is configured to determine an allocated resource.

According to another aspect of the embodiments of the present disclosure, there is provided a communication device, where the device includes a processor and a memory, the memory stores a computer program, and the processor executes the computer program stored in the memory so that the device performs the method according to the above aspect of the embodiments.

According to another aspect of the embodiments of the present disclosure, there is provided a communication device, including: a processor and an interface circuit, where
the interface circuit is configured to receive code instructions and transmit them to the processor; and
the processor is configured to run the code instructions to perform the method according to the above aspect of the embodiments.

According to another aspect of the embodiments of the present disclosure, there is provided a computer-readable storage medium for storing instructions, when the instructions are executed, the method according to the above aspect of the embodiments is implemented.

### BRIEF DESCRIPTION OF THE DRAWINGS

The above and/or additional aspects and advantages of the present disclosure will become apparent and easy to understand from the following description of the embodiments in conjunction with the accompanying drawings, wherein:

FIG. 1 and FIG. 2 are schematic diagrams of the time-frequency resources of the data receiving terminal #A and the data receiving terminal #B in the related art;

FIG. 3 is a stereoscopic diagram and a plan view of the radar detection of the base station to the data receiving terminal A and the data receiving terminal #B under the allocation method shown in FIG. 1;

FIG. 4 is a stereoscopic diagram and a plan view of the radar detection of the base station to the data receiving terminal A and the data receiving terminal #B under the allocation method shown in FIG. 2;

FIG. 5 is a flow chart of a resource allocation method provided in an embodiment of the present disclosure;

FIG. 6 is a flow chart of a resource allocation method provided in an embodiment of the present disclosure;

FIG. 7a is a flow chart of a resource allocation method provided in an embodiment of the present disclosure;

FIG. 7b is a schematic diagram of the time-frequency resources of UE #A when the method shown in FIG. 7a is used to allocate resources provided in an embodiment of the present disclosure;

FIG. 7c is a stereoscopic diagram and a plan view of radar detection of UE using the method shown in FIG. 7a provided by an embodiment of the present disclosure;

FIG. 8a is a flow chart of a resource allocation method provided by an embodiment of the present disclosure;

FIG. 8b is a schematic diagram of the time-frequency resources of UE #A when allocating resources using the method shown in FIG. 8a provided by an embodiment of the present disclosure;

FIG. 8c is a stereoscopic diagram and a plan view of radar detection of UE using the method shown in FIG. 8a provided by an embodiment of the present disclosure;

FIG. 9 is a structural schematic diagram of a data sending device provided by an embodiment of the present disclosure;

FIG. 10 is a structural schematic diagram of a data receiving device provided by an embodiment of the present disclosure;

FIG. 11 is a structural schematic diagram of an echo receiving device provided by an embodiment of the present disclosure;

FIG. 12 is a block diagram of a user equipment provided by an embodiment of the present disclosure;

FIG. 13 is a block diagram of a network-side device provided by an embodiment of the present disclosure.

### DETAILED DESCRIPTION

Here, example embodiments will be described in detail, examples of which are shown in the accompanying drawings. When the following description refers to the drawings, unless otherwise indicated, the same numbers in different drawings represent the same or similar elements. The embodiments described in the following example embodiments do not represent all embodiments consistent with the embodiments of the present disclosure. Instead, they are only examples of devices and methods consistent with some aspects of the embodiments of the present disclosure as detailed in the attached claims.

The terms used in the embodiments of the present disclosure are only for the purpose of describing specific embodiments and are not intended to limit the embodiments of the present disclosure. The singular forms “a” and “the” used in the embodiments of the present disclosure and the attached claims are also intended to include the plural forms unless the context clearly indicates other meanings. It should also be understood that the term “and/or” used herein refers to and includes any or all possible combinations of one or more associated listed items.

It should be understood that although the terms first, second, third, etc. may be used in the embodiments of the present disclosure to describe various information, the information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the words “if” as used herein may be interpreted as “upon . . . ” or “when . . . ” or “in response to determining”.

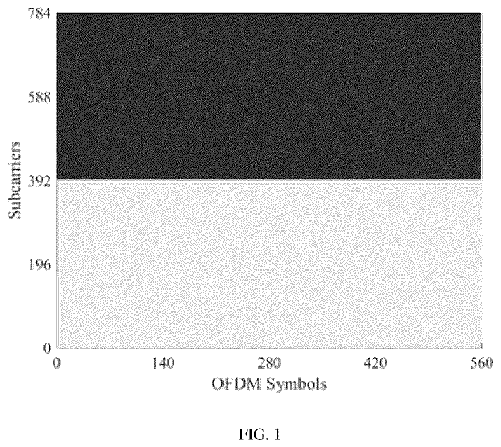

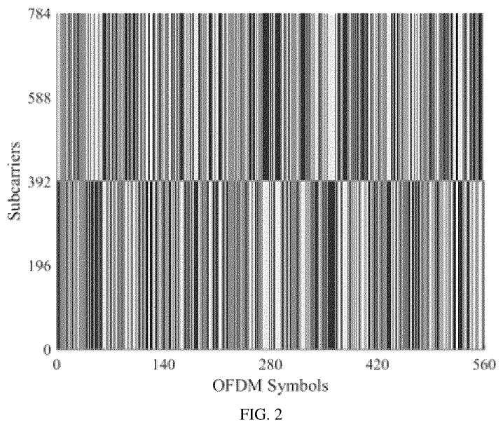

In the related art, when there are multiple data receiving terminals in the ISAC system, frequency domain resources will be allocated to respective data receiving terminals. The specific method is as follows: sort the subcarrier indexes corresponding to the time domain symbol from small to large, and divide the subcarrier index sequence into K subcarrier groups according to the index order, where K is the number of data receiving terminals in the ISAC system, and then, allocate a subcarrier group to each of the K data receiving terminals for frequency domain resource allocation. It is assumed that the total number of subcarriers corresponding to one symbol is 784, and there are two data receiving terminals in the ISAC system, namely data receiving terminal #A and data receiving terminal #B. FIG. 1 and FIG. 2 are schematic diagrams of the time-frequency resources of data receiving terminal #A and data receiving terminal #B in the related art. The white parts in FIG. 1 and FIG. 2 represent the subcarriers occupied by data receiving terminal #A, and the black parts represent the subcarriers not occupied by data receiving terminal #A. In addition, the subcarrier positions in different OFDM symbol durations in FIG. 1 are fixed, and the subcarrier positions in different OFDM symbol durations in FIG. 2 change randomly.

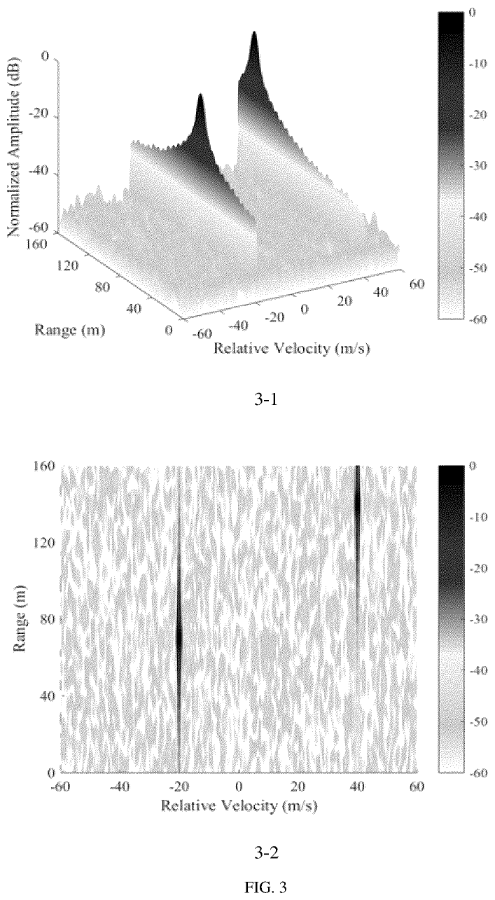

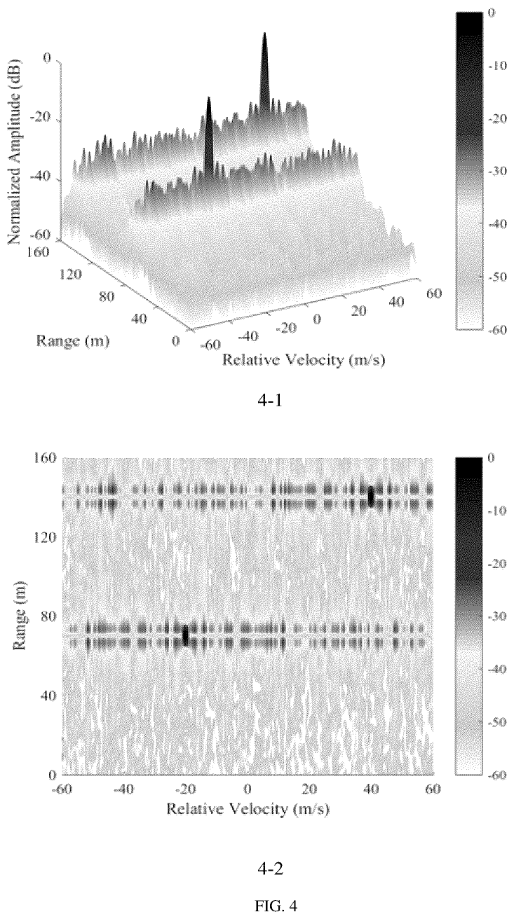

However, the frequency domain resource allocation method in the related art will make the signal correlation between the subcarriers of the data receiving terminal larger, thereby affecting the detection effect for respective data receiving terminals. Specifically, it is assumed that the modulation mode is Quadrature Phase Shift Keying (QPSK) and the signal to noise ratio (SNR) is set to 0 dB. FIG. 3 is a stereoscopic diagram and a plan diagram of radar detection of the base station to the data receiving terminal #A and the data receiving terminal #B under the allocation method shown in FIG. 1, where FIG. 3-1 is a stereoscopic diagram of radar detection and FIG. 3-2 is a plan diagram of radar detection. FIG. 4 is a stereoscopic diagram and a plan diagram of radar detection of the base station to the data receiving terminal #A and the data receiving terminal #B under the allocation method shown in FIG. 2, where FIG. 4-1 is a stereoscopic diagram of radar detection and FIG. 4-2 is a plan diagram of radar detection. It can be seen from FIG. 3 and FIG. 4 that when the allocation method shown in FIG. 1 is used to allocate frequency domain resources to the data receiving terminal, there is a distance expansion phenomenon on the distance axis (vertical axis) when detecting the data receiving terminal. When the allocation method shown in FIG. 2 is used to allocate frequency domain resources to the data receiving terminal, there is a speed expansion phenomenon on the speed axis (horizontal axis) when detecting the data receiving terminal. The secondary peak is higher and the side lobes are more, which will make the detection effect unsatisfactory and make it impossible to accurately detect the distance and speed of the data receiving terminal.

The resource allocation method, device, apparatus and storage medium provided by the embodiment of the present disclosure are described in detail with reference to the accompanying drawings.

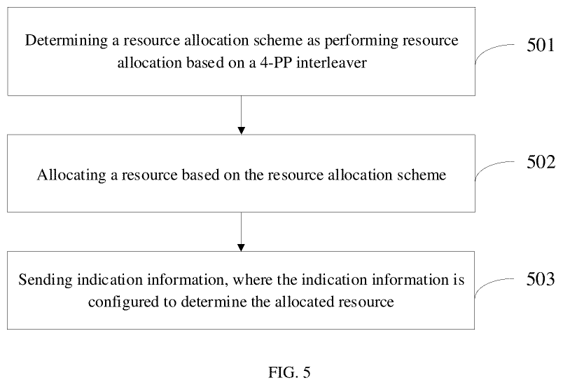

FIG. 5 is a flow chart of a resource allocation method provided by the embodiment of the present disclosure. As shown in FIG. 5, the resource allocation method may include the following steps:

Step 501, determining a resource allocation scheme as performing resource allocation based on a 4-PP interleaver.

The method of the embodiment of the present disclosure may be applicable to an active radar system and/or a passive radar system. The active radar system and the passive radar system generally include a data sending terminal, a data receiving terminal and an echo receiving terminal. The data sending terminal and the echo receiving terminal may be a base station or a user equipment (UE), and the data receiving terminal is a UE.

In the active radar system, the data sending terminal and the echo receiving terminal are the same device. The data sending terminal sends bit data to the data receiving terminal, and the data receiving terminal completes the communication function as a receiver. The data sending terminal sends the bit data illuminated on the data receiving terminal to generate the echo signal, which is transmitted back to the echo receiving terminal (i.e., the data sending terminal). The echo receiving terminal detects the speed, distance, and other information of the data receiving terminal through the radar processor to complete the radar function. In a passive radar, the data sending terminal and the echo receiving terminal are different devices, and there may be multiple echo receiving terminals. The data sending terminal sends the bit data to the data receiving terminal, and the data receiving terminal completes the communication function as a receiver. The data sending terminal sends the bit data illuminated on the data receiving terminal to generate the echo signal, which is transmitted back to the echo receiving terminal. The echo receiving terminal detects the speed, distance, and other information of the data receiving terminal through the radar processor to complete the radar function.

It should be noted that in one embodiment of the present disclosure, UE may refer to a device that provides voice and/or data connectivity to a user. The terminal device can communicate with one or more core networks via the Radio Access Network (RAN). The UE can be an IoT terminal, such as a sensor device, a mobile phone (or a “cellular” phone), and a computer with an IoT terminal. For example, it may be a fixed, portable, pocket-sized, handheld, computer-built-in, or vehicle-mounted device. For example, it may be a station (STA), a subscriber unit, a subscriber station, a mobile station, a mobile, a remote station, an access point, a remote terminal, an access terminal, a user terminal, or a user agent. Alternatively, the UE can also be a device of an unmanned aerial vehicle. Alternatively, the UE can also be a vehicle-mounted device, such as a driving computer with wireless communication function, or a wireless terminal connected to an external driving computer. Alternatively, the UE can also be a roadside device, such as a street lamp, a signal lamp, or other roadside device with wireless communication function.

Further, in one embodiment of the present disclosure, the above-mentioned method for determining the resource allocation scheme may include at least one of the following:
obtaining the resource allocation scheme sent by the network device (base station and/or core network device);
determining the resource allocation scheme based on the protocol agreement;
obtaining the resource allocation scheme sent by the base station, where the resource allocation scheme is pre-configured to the base station by the core network device;
obtaining the resource allocation scheme sent by the base station, where the resource allocation scheme is pre-configured to the base station by other base station;
determining the resource allocation scheme on its own, that is, determining the configuration scheme to be adopted on its own according to the actual situation or demand.

Step 502, allocating a resource based on the resource allocation scheme.

Specifically, in one embodiment of the present disclosure, the frequency domain resource allocation is mainly performed on the data receiving terminal of the ISAC system by using a 4-PP interleaver. This part of the content will be described in detail in subsequent embodiments.

Step 503, sending indication information, where the indication information is configured to determine the allocated resource.

In one embodiment of the present disclosure, the indication information may include the frequency domain resources corresponding to respective data receiving terminals.

In summary, in the resource allocation method provided in the embodiment of the present disclosure, the resource allocation scheme is first determined as performing resource allocation based on the 4-PP interleaver; then, resources are allocated based on the resource allocation scheme, and indication information is sent, which is configured to determine the allocated resources. It can be seen that in the embodiment of the present disclosure, the 4-PP interleaver is introduced when allocating resources to the data receiving terminal, thereby avoiding the allocation of continuous frequency domain resources to the data receiving terminal, reducing the signal correlation between the subcarriers of the data receiving terminal, thereby ensuring the detection effect for the data receiving terminal, improving the detection performance of the ISAC system, and facilitating the detection of moving targets in the ISAC system.

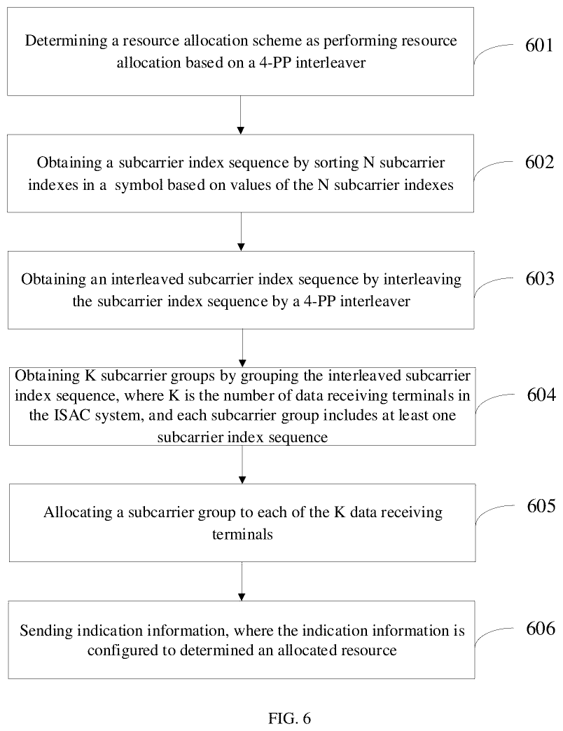

FIG. 6 is a flow chart of a resource allocation method provided in the embodiment of the present disclosure. As shown in FIG. 6, the resource allocation method may include the following steps:

Step 601, determining a resource allocation scheme as performing resource allocation based on a 4-PP interleaver.

The detailed description of step 601 can refer to the description of the above embodiment, and will not be repeated in the embodiment of the present disclosure.

Step 602, obtaining a subcarrier index sequence by sorting N subcarrier indexes in a symbol (such as orthogonal frequency division multiplexing (OFDM) symbol) based on values of the N subcarrier indexes.

In one embodiment of the present disclosure, the N subcarrier indexes in the symbol can be sorted in an ascending or a descending order. For example, the obtained subcarrier index sequence can be (0,1, . . . , N−1).

Step 603, obtaining an interleaved subcarrier index sequence by interleaving the subcarrier index sequence by a 4-PP interleaver.

Specifically, in one embodiment of the present disclosure, the method for interleaving can mainly include the following steps:

Step a, determining a parameter configuration of the 4-PP interleaver.

In one embodiment of the present disclosure, the parameter configuration of the 4-PP interleaver can include at least one of the following:
a 4-PP interleaver function;
a decomposition formula corresponding to the 4-PP interleaver; and
a parameter value rule in the 4-PP interleaver function.

Specifically, the above-mentioned 4-PP interleaver function can be:

$$π ( i ) = ( {f}_{1} \cdot i + {f}_{2} \cdot {i}^{2} + {f}_{3} \cdot {i}^{3} + {f}_{4} \cdot {i}^{4} ) mod N \qquad ( 1 )$$

where i indicates the i-th bit of the interleaved subcarrier index sequence, π(i) is the value of the i-th bit of the interleaved subcarrier index sequence, f₁, f₂, f₃ and f₄ are four parameters of the 4-PP interleaver, and the parameter value rule is configured to determine the values of f₁, f₂, f₃ and f₄.

The decomposition formula corresponding to the above 4-PP interleaver can be:

$$N = {Π}_{i = 1}^{ω ( N )} {p}_{i}^{{α}_{N , i}} \qquad ( 2 )$$

where ω(N) is a positive integer, pᵢ is a factor of N, and α_{N,i} is the corresponding exponent.

The above parameter value rule can be:
when pᵢ=2 and α_{N,i}>1, the following condition must be met:

$${f}_{1} \neq 0 , ( {f}_{2} + {f}_{4} ) = 0 , {f}_{3} = 0 ( mod 2 ) \qquad ( 3 )$$

when 3ł(pᵢ−1), the following condition must be met:

$${f}_{1} \neq 0 , {f}_{2} = 0 , {f}_{3} = 0 , {f}_{4} = 0 ( mod {p}_{i} ) \qquad ( 4 )$$

In one embodiment of the present disclosure, the method for determining the parameter configuration of the 4-PP interleaver may include at least one of the following:
obtaining the parameter configuration of the 4-PP interleaver sent by the network device;
determining the parameter configuration of the 4-PP interleaver based on the protocol agreement;
obtaining the parameter configuration of the 4-PP interleaver sent by the base station, where the parameter configuration of the 4-PP interleaver is pre-configured to the base station by the core network device; and
obtaining the parameter configuration of the 4-PP interleaver sent by the base station, where the parameter configuration of the 4-PP interleaver is pre-configured to the base station by other base station.

Step b, determining the values of pᵢ and α_{N,i} by decomposing N based on the decomposition formula.

For example, in one embodiment of the present disclosure, assuming that N is 20, N can be decomposed into: 2²×5=20 based on the decomposition formula (2); at this time, it can be determined that pᵢ=2 and 5, α_{N,i}=2 and 1.

Step c, determining the values of f₁, f₂, f₃ and f₄ based on the values of pᵢ and α_{N,i} and the parameter value rule.

Specifically, the condition that the values of f₁, f₂, f₃ and f₄ need to meet can be determined based on the values of pᵢ and α_{N,i} and then the values of f₁, f₂, f₃ and f₄ can be determined based on the condition that the values of f₁, f₂, f₃ and f₄ need to meet.

For example, assuming that when N is 20 and is decomposed into: 2²×5=20, it can be determined that f₁=17, f₂=200, f₃=20 and f₄=40.

Step d, calculating the interleaved subcarrier index sequence based on the 4-PP interleaver function.

Specifically, the values of f₁, f₂, f₃ and f₄ determined in the above step c can be brought into the above 4-PP interleaver function (1), and the interleaved subcarrier index sequence can be calculated based on the 4-PP interleaver function (1).

For example, assuming that the uninterleaved subcarrier index sequence is (0, 1, 2, 3, 4, 5, 6, 7, 8, 9, 10, 11, 12, 13, 14, 15, 16, 17, 18, 19), the parameters of the 4-PP interleaver are set to f₁=17, f₂=200, f₃=20 and f₄=40, then the interleaved subcarrier index sequence is (17, 14, 11, 8, 5, 2, 19, 16, 13, 10, 7, 4, 1, 18, 15, 12, 9, 6, 3, 0).

Step 604: obtaining K subcarrier groups by sequentially grouping the interleaved subcarrier index sequence, where K is the number of data receiving terminals in the ISAC system, and each subcarrier group includes at least one subcarrier index sequence.

It should be noted that, in one embodiment of the present disclosure, the K subcarrier groups shall meet the following conditions:
in response to N being divisible by K, the numbers of subcarrier indexes contained in the K subcarrier groups are the same (for example, the number can be the value of N divided by K);
in response to N not being divisible by K, the numbers of subcarrier indexes contained in d subcarrier groups among the K subcarrier groups are the same, the numbers of subcarrier indexes contained in other subcarrier groups are the same (the number can be an integer of the quotient of N divided by K), and the numbers of subcarrier indexes contained in d subcarrier groups are 1 more than the numbers of subcarrier indexes contained in other subcarrier groups, where d is the value of N modulo K. In addition, the number of subcarrier indexes contained in d subcarrier groups can be the integer of the quotient of N divided by K plus 1, and the number of subcarrier indexes contained in other subcarrier groups can be an integer of the quotient of N divided by K.

For example, in one embodiment of the present disclosure, assuming that N is 20, K is 2, and N is divisible by K, then the interleaved subcarrier index sequence can be divided into 2 subcarrier groups, and the number of subcarrier indexes contained in the 2 subcarrier groups is the same, such as 10. Based on this, assuming that the interleaved subcarrier index sequence is (17, 14, 11, 8, 5, 2, 19, 16, 13, 10, 7, 4, 1, 18, 15, 12, 9, 6, 3, 0), then the first 10 subcarrier indexes in the interleaved subcarrier index sequence can be divided into subcarrier group #1, subcarrier group #1 is (17, 14, 11, 8, 5, 2, 19, 16, 13, 10), and the last 10 subcarrier indexes in the interleaved subcarrier index sequence can be divided into subcarrier group #2, subcarrier group #2 is (7, 4, 1, 18, 15, 12, 9, 6, 3, 0).

For example, in another embodiment of the present disclosure, assuming that N is 20, K is 3, and N is not divisible by K, then the value of N modulo K is determined, denoted as d=2. At this time, the interleaved subcarrier index sequence can be divided into 3 subcarrier groups, and the number of subcarrier indexes contained in certain 2 subcarrier groups among the 3 subcarrier groups is the same, the number of subcarrier indexes contained in the remaining 1 subcarrier group among the 3 subcarrier groups is different from the number of subcarrier indexes contained in the certain 2 subcarrier groups, and the number of subcarrier indexes contained in the certain 2 subcarrier groups is 1 more than the number of subcarrier indexes contained in the remaining 1 subcarrier group. Based on this, assuming that the interleaved subcarrier index sequence is (17, 14, 11, 8, 5, 2, 19, 16, 13, 10, 7, 4, 1, 18, 15, 12, 9, 6, 3, 0), then the first 7 subcarrier indexes in the interleaved subcarrier index sequence can be divided into subcarrier group #1, subcarrier group #1 is (17, 14, 11, 8, 5, 2, 19), the 8th to 14th subcarrier indexes in the interleaved subcarrier index sequence are divided into subcarrier group #2, subcarrier group #2 is (16, 13, 10, 7, 4, 1, 18), and the 15th to 20th subcarrier indexes in the interleaved subcarrier index sequence are divided into subcarrier group #3, subcarrier group #3 is (15, 12, 9, 6, 3, 0). Alternatively, the first 6 subcarrier indexes and the second-to-last subcarrier index in the interleaved subcarrier index sequence can be divided into subcarrier group #1, and subcarrier group #1 is (17, 14, 11, 8, 5, 2, 3), the 7th to 12th subcarrier indexes and the last subcarrier index in the interleaved subcarrier index sequence can be divided into subcarrier group #2, and subcarrier group #2 is (19, 16, 13, 10, 7, 4, 0), and the 13th to 18th subcarrier indexes in the interleaved subcarrier index sequence can be divided into subcarrier group #3, and subcarrier group #3 is (1, 18, 15, 12, 9, 6). That is, in the embodiments of the present disclosure, the subcarrier indexes in the interleaved subcarrier index sequence can be divided in order to obtain K subcarrier groups, or they can be divided in no order to obtain K subcarrier groups.

Step 605: allocating a subcarrier group to each of the K data receiving terminals, where a subcarrier corresponding to a subcarrier index in each subcarrier group is a frequency domain resource allocated to the data receiving terminal.

In one embodiment of the present disclosure, the Kth subcarrier group can be allocated to the Kth data receiving terminal. For example, it is assumed that there are two data receiving terminals in the ISAC system, namely, data receiving terminal #A and data receiving terminal #B, and the obtained K subcarrier groups are subcarrier group #1 and subcarrier group #2, then subcarrier group #1 can be allocated to data receiving terminal #A, and subcarrier group #2 can be allocated to data receiving terminal #B. At this time, the subcarriers corresponding to the subcarrier indexes in subcarrier group #1 are the frequency domain resources allocated to data receiving terminal #A (for example, when subcarrier group #1 is (17, 14, 11, 8, 5, 2, 19, 16, 13, 10), the subcarriers with subcarrier indexes of 17, 14, 11, 8, 5, 2, 19, 16, 13, 10 in the symbol can be determined as the frequency domain resources of data receiving terminal #A), and the subcarriers corresponding to the subcarrier indexes in subcarrier group #2 are the frequency domain resources allocated to data receiving terminal #B (for example, when subcarrier group #2 is (7, 4, 1, 18, 15, 12, 9, 6, 3, 0), the subcarriers with subcarrier indexes of 7, 4, 1, 18, 15, 12, 9, 6, 3, 0 are determined as the frequency domain resources of the data receiving terminal #B).

It can be seen from the above steps 602 and 603 that in the embodiment of the present disclosure, a 4-PP interleaver is used to interleave the sequentially sorted subcarrier index sequence to disrupt the order, and obtain an interleaved subcarrier index sequence, where the subcarrier indexes in the interleaved subcarrier index sequence are not sorted in order. Then, the interleaved subcarrier index sequence is grouped to obtain a subcarrier group by executing steps 604 and 605, and the subcarrier group is allocated to the data receiving terminal. Since the subcarrier indexes in the interleaved subcarrier index sequence are not sorted in order, the subcarrier indexes in the subcarrier group obtained by grouping should also not be sorted in order, so that the subcarrier indexes of the subcarriers allocated to respective data receiving terminals are not sorted in order, that is, the subcarriers allocated to respective data receiving terminals are non-continuous subcarriers. When the data receiving terminal communicates based on the non-continuous subcarriers subsequently, the signal correlation between the subcarriers of the data receiving terminal can be reduced, ensuring the detection effect for the data receiving terminal.

Step 606, sending indication information, where the indication information is configured to determine the allocated resources.

In one embodiment of the present disclosure, the indication information may include frequency domain resources corresponding to respective data receiving terminals. For example, the indication information includes the frequency domain resource of the data receiving terminal #A being subcarrier group #1, and the frequency domain resource of the data receiving terminal #B being subcarrier group #2.

In summary, in the resource allocation method provided in the embodiment of the present disclosure, the resource allocation scheme is first determined as performing resource allocation based on the 4-PP interleaver; then, resources are allocated based on the resource allocation scheme, and indication information is sent, and the indication information is configured to determine the allocated resources. It can be seen that in the embodiment of the present disclosure, the 4-PP interleaver is introduced when allocating resources to the data receiving terminal, thereby avoiding the allocation of continuous frequency domain resources to the data receiving terminal, reducing the signal correlation between the subcarriers of the data receiving terminal, thereby ensuring the detection effect for the data receiving terminal, improving the detection performance of the ISAC system, and facilitating the detection of moving targets in the ISAC system.

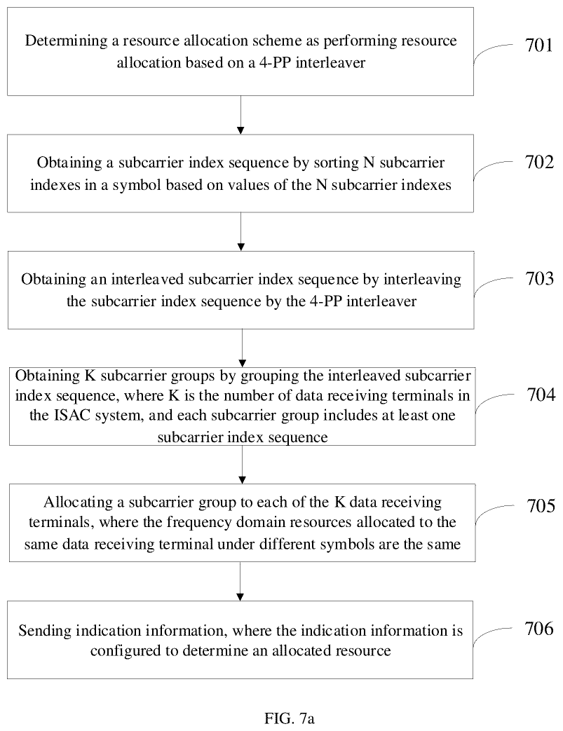

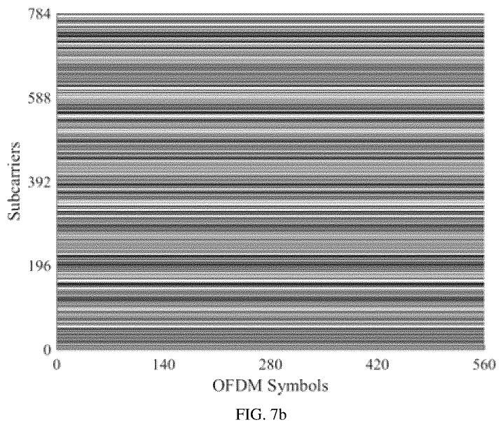

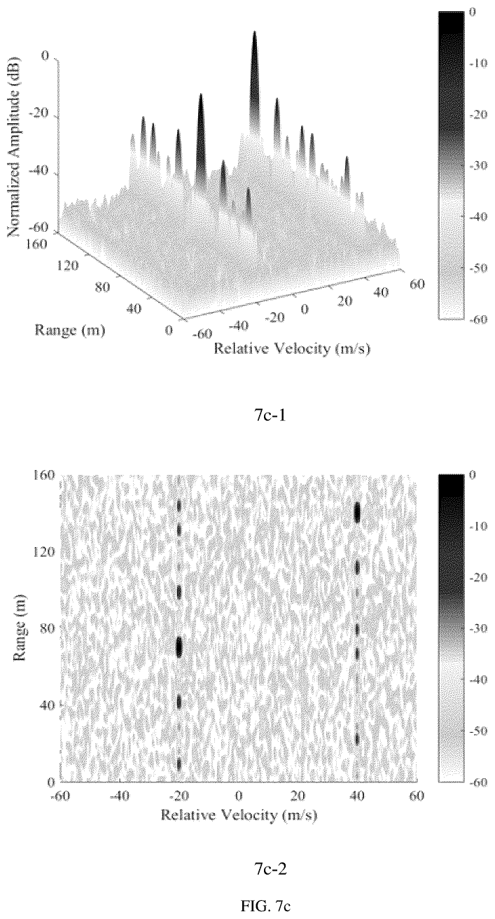

FIG. 7a is a flow chart of a resource allocation method provided in the embodiment of the present disclosure. As shown in FIG. 7a, the resource allocation method may include the following steps:

Step 701, determining a resource allocation scheme as performing resource allocation based on a 4-PP interleaver.

Step 702, obtaining a subcarrier index sequence by sorting N subcarrier indexes in a symbol based on values of the N subcarrier indexes.

Step 703, obtaining an interleaved subcarrier index sequence by interleaving the subcarrier index sequence by the 4-PP interleaver.

Step 704, obtaining K subcarrier groups by grouping the interleaved subcarrier index sequence, where K is the number of data receiving terminals in the ISAC system, and each subcarrier group includes at least one subcarrier index sequence.

The detailed description of steps 701-704 can refer to the description of the above embodiment, and will not be repeated in the embodiment of the present disclosure.

Step 705, allocating a subcarrier group to each of the K data receiving terminals, where a subcarrier corresponding to a subcarrier index in each subcarrier group is the frequency domain resource allocated to the data receiving terminal, and the frequency domain resources allocated to the same data receiving terminal under different symbols are the same.

In one embodiment of the present disclosure, it is assumed that the basic parameters of the ISAC system are as shown in Table 1, and it is assumed that there are two UEs A and B in the ISAC system as data receiving terminals, where the speed and distance information of the two UEs are as shown in Table 2.

TABLE 1
Basic parameters of the ISAC system

| Parameter name | Value | |
|---|---|---|
| Carrier frequency | 24 | GHz |
| Subcarrier interval | 60 | kHz |
| Number of subcarriers | 784 | |
| Total Symbol Bandwidth | 47 | MHz |
| Number of OFDM symbols | 560 | |
| OFDM prefix duration | 1.17 | us |
| OFDM symbol time | 16.67 | us |
| Complete OFDM symbol duration | 17.84 | us |

| | |
|---|---|
| Number of BS (base station) antennas | 1 |
| Number of UE antennas | 1 |

TABLE 2
speed information and distance information for UEs

| UE | Distance (m) | Speed (m/s) |
|---|---|---|
| A | 140 | 40 |
| B | 70 | −20 |

Based on the basic parameters in Table 1, it can be determined that UE #A and UE #B each occupy 392 of the N=784 subcarriers, and the subcarrier indexes of UE #A and UE #B are calculated by the 4-PP interleaver, and the subcarrier indexes of UE #A and UE #B remain unchanged within 560 OFDM symbol durations. FIG. 7b is a schematic diagram of the time-frequency resources of UE #A when resources are allocated using the method shown in FIG. 7a provided in an embodiment of the present disclosure, where the white parts represent the subcarriers occupied by UE #A, and the black parts represent the subcarriers not occupied by UE #A. It should be noted that FIG. 7b is a schematic diagram obtained when resources are allocated based on the 4-PP interleaver function when f₁=199, f₂=7, f₃=560 and f₄=777, and FIG. 7c is a stereoscopic diagram and a plan view of radar detection of UE using the method shown in FIG. 7a provided in an embodiment of the present disclosure, where FIG. 7c-1 is a stereoscopic diagram of radar detection, and FIG. 7c-2 is a plan view of radar detection. As shown in FIG. 7c, when the frequency domain resources are allocated to the UE using the allocation method shown in FIG. 7a, when detecting the UE, although the side lobes are more obvious, the distance expansion phenomenon on the distance axis (vertical axis) is significantly alleviated, thereby ensuring the detection effect to a certain extent.

Step 706, sending indication information, where the indication information is configured to determine the allocated resources.

In one embodiment of the present disclosure, the indication information may include the frequency domain resources corresponding to respective data receiving terminals. For example, the indication information includes the frequency domain resource of the data receiving terminal #A being subcarrier group #1, and the frequency domain resource of the data receiving terminal #B being subcarrier group #2.

In summary, in the resource allocation method provided in the embodiment of the present disclosure, the resource allocation scheme will be first determined as performing resource allocation based on a 4-PP interleaver; then, resources are allocated based on the resource allocation scheme, and indication information is sent, the indication information is configured to determine the allocated resources. It can be seen that in the embodiment of the present disclosure, a 4-PP interleaver is introduced when allocating resources to the data receiving terminal, thereby avoiding allocating continuous frequency domain resources to the data receiving terminal, reducing the signal correlation between the subcarriers of the data receiving terminal, thereby ensuring the detection effect for the data receiving terminal, improving the detection performance of the ISAC system, and facilitating the detection of moving targets in the ISAC system.

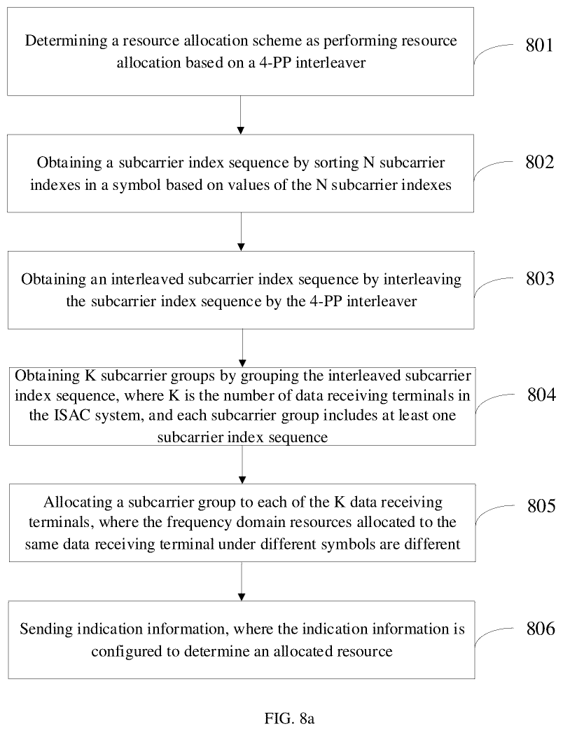

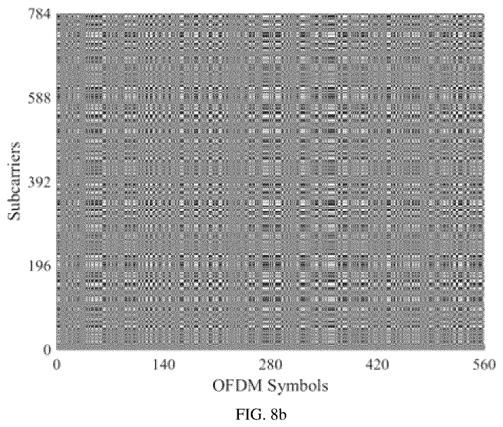

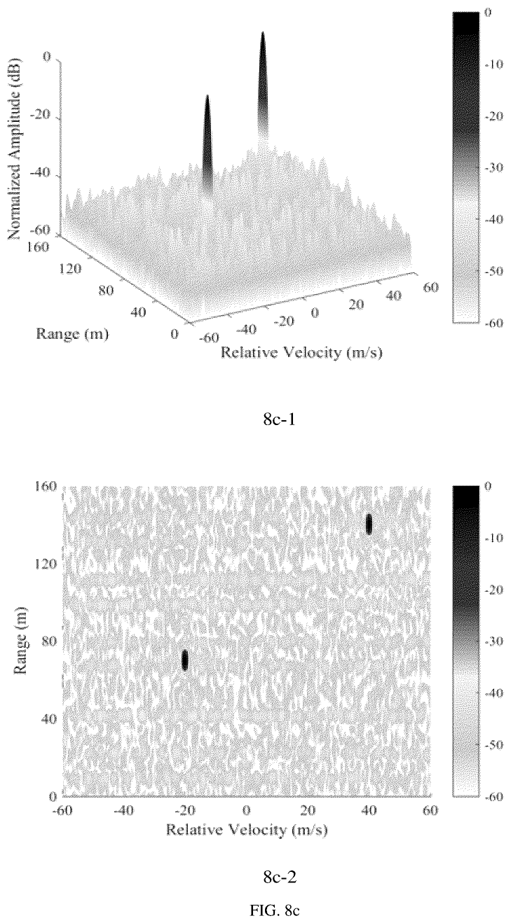

FIG. 8a is a flow chart of a resource allocation method provided by the embodiment of the present disclosure. As shown in FIG. 8a, the resource allocation method may include the following steps:

Step 801, determining a resource allocation scheme as performing resource allocation based on a 4-PP interleaver.

Step 802, obtaining a subcarrier index sequence by sorting N subcarrier indexes in a symbol based on values of the N subcarrier indexes.

Step 803, obtaining an interleaved subcarrier index sequence by interleaving the subcarrier index sequence by the 4-PP interleaver.

Step 804, obtaining K subcarrier groups by grouping the interleaved subcarrier index sequence, where K is the number of data receiving terminals in the ISAC system, and each subcarrier group includes at least one subcarrier index sequence.

The detailed description of steps 801-804 can refer to the description of the above embodiment, and will not be repeated in the embodiment of the present disclosure.

Step 805, allocating a subcarrier group to each of the K data receiving terminals, where a subcarrier corresponding to a subcarrier index in each subcarrier group is the frequency domain resource allocated to the data receiving terminal, and the frequency domain resources allocated to the same data receiving terminal under different symbols are different.

In one embodiment of the present disclosure, it is assumed that the basic parameters of the ISAC system are as shown in Table 1 above, and it is assumed that there are two UEs A and B in the ISAC system as data receiving terminals, where the speed and distance information of the two UEs are as shown in Table 2 above.

Based on the basic parameters in Table 1, it can be determined that UE #A and UE #B each occupy 392 of the N=784 subcarriers, and the subcarrier indexes of UE #A and UE #B are calculated by the 4-PP interleaver, and the subcarrier indexes of UE #A and UE #B change within 560 OFDM symbol durations. FIG. 8b is a schematic diagram of the time-frequency resources of UE #A when resources are allocated using the method shown in FIG. 8a provided by the embodiment of the present disclosure, where the white parts represent the subcarriers occupied by UE #A, and the black parts represent the subcarriers not occupied by UE #A. It should be noted that FIG. 8b is a schematic diagram obtained when resources are allocated based on the 4-PP interleaver function when f₁=199, f₂=7, f₃=560 and f₄=777, and FIG. 8c is a stereogram and a plan view of radar detection of UE using the method shown in FIG. 8a provided by the embodiment of the present disclosure, where FIG. 8c-1 is a stereogram of radar detection, and FIG. 8c-2 is a plan view of radar detection. It can be seen from FIG. 8c that when frequency domain resources are allocated to UE using the allocation method shown in FIG. 8a, there is no obvious side peak when detecting UE, and the two UEs can be distinguished more clearly, with better detection effect.

Step 806: sending indication information, where the indication information is configured to determine the allocated resources.

In one embodiment of the present disclosure, the indication information may include frequency domain resources corresponding to respective data receiving terminals. For example, the indication information includes the frequency domain resource of data receiving terminal #A being subcarrier group #1, and the frequency domain resource of data receiving terminal #B being subcarrier group #2.

In summary, in the resource allocation method provided in the embodiment of the present disclosure, the resource allocation scheme will be first determined as performing resource allocation based on 4-PP interleaver; then, resources are allocated based on the resource allocation scheme, and indication information is sent, and the indication information is configured to determine the allocated resources. It can be seen that in the embodiment of the present disclosure, when allocating resources to the data receiving terminal, the 4-PP interleaver is introduced, thereby avoiding the allocation of continuous frequency domain resources to the data receiving terminal, reducing the signal correlation between the subcarriers of the data receiving terminal, thereby ensuring the detection effect for the data receiving terminal, improving the detection performance of the ISAC system, and facilitating the detection of moving targets in the ISAC system.

In addition, the execution subject of the method of FIGS. 5 to 8a above is introduced (the following content takes the data sending terminal being the base station and the data receiving terminal being the UE as an example).

In one embodiment of the present disclosure, the method of FIGS. 5-8a above can be performed by a base station (i.e., a data transmitting terminal). That is, the base station determines the resource allocation scheme as follows: performing resource allocation based on a 4-PP interleaver, and allocating resources based on the resource allocation method, and then sending the indication information for determining the allocated resources to the UE (i.e., a data receiving terminal), so that the UE determines the frequency domain resources allocated to it based on the indication information. The method for the base station to determine the resource allocation scheme can be at least one of the following: obtaining the resource allocation scheme sent by the core network device, determining the resource allocation scheme based on the protocol agreement, obtaining the resource allocation scheme sent by other base station (where the resource allocation scheme of other base station is configured by the core network device or another base station), and determining the resource allocation scheme by the base station itself. It should be noted that in one embodiment of the present disclosure, after determining the resource allocation scheme, the base station as the data sending terminal can also send the resource allocation scheme it determines to the UE, so that the UE can determine the frequency domain resources allocated to it based on the resource allocation scheme.

In another embodiment of the present disclosure, the base station and the UE can both perform the method of FIGS. 5 to 8a above. That is, the base station and the UE can both first determine the resource allocation scheme as performing resource allocation based on the 4-PP interleaver, and both allocate resources based on the resource allocation scheme. The method for the UE to determine the resource allocation scheme can be as follows: the UE obtains the resource allocation scheme sent by the base station, and/or determines the resource allocation scheme based on the protocol agreement.

In another embodiment of the present disclosure, the method of FIGS. 5 to 8a above can be performed by other base station (i.e., different from the base station as the data sending terminal). That is, other base station first determine the resource allocation scheme as performing resource allocation based on the 4-PP interleaver, and allocate resources based on the resource allocation scheme, and then send indication information to the base station as the data sending terminal and the UE as the data receiving terminal, so that the two determine the frequency domain resources allocated to the UE.

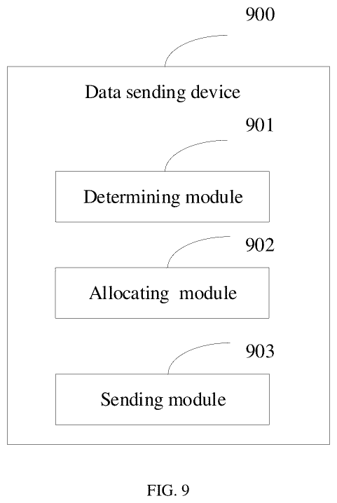

FIG. 9 is a schematic diagram of a structure of a data sending device provided by an embodiment of the present disclosure. As shown in FIG. 9, the device includes:
a determining module 901, configured to determine the resource allocation scheme as performing resource allocation based on a 4-PP interleaver;
an allocating module 902, configured to allocate resources based on the resource allocation scheme; and
a sending module 903, configured to send indication information, where the indication information is configured to determine the allocated resources.

In summary, in the device provided by the embodiment of the present disclosure, the resource allocation scheme is first determined as performing resource allocation based on a 4-PP interleaver; then, resources are allocated based on the resource allocation scheme, and indication information is sent, the indication information is configured to determine the allocated resources. It can be seen that in the embodiment of the present disclosure, a 4-PP interleaver is introduced when allocating resources to the data receiving terminal, thereby avoiding the allocation of continuous frequency domain resources to the data receiving terminal, reducing the signal correlation between the subcarriers of the data receiving terminal, thereby ensuring the detection effect for the data receiving terminal, improving the detection performance of the ISAC system, and facilitating the detection of moving targets in the ISAC system.

For example, in one embodiment of the present disclosure, the allocating module is configured to:
obtain a subcarrier index sequence by sorting N subcarrier indexes in a symbol based on values of the N subcarrier indexes;
obtain an interleaved subcarrier index sequence by interleaving the subcarrier index sequence by the 4-PP interleaver;
obtain K subcarrier groups by grouping the interleaved subcarrier index sequence, where K is the number of data receiving terminals, and each subcarrier group includes at least one subcarrier index sequence;
allocate a subcarrier group to each of the K data receiving terminals, where a subcarrier corresponding to a subcarrier index in each subcarrier group is a frequency domain resource allocated to the data receiving terminal.

For example, in one embodiment of the present disclosure, the device is further configured to:
determine a parameter configuration of the 4-PP interleaver;
where the parameter configuration of the 4-PP interleaver includes at least one of the following:
a 4-PP interleaver function;
a decomposition formula corresponding to the 4-PP interleaver; and
a parameter value rule in the 4-PP interleaver function.

For example, in one embodiment of the present disclosure, the 4-PP interleaver function is:

$$π ( i ) = ( {f}_{1} \cdot i + {f}_{2} \cdot {i}^{2} + {f}_{3} \cdot {i}^{3} + {f}_{4} \cdot {i}^{4} ) mod N \qquad ( 1 )$$

where i indicates the i-th bit of the interleaved subcarrier index sequence, π(i) is the value of the i-th bit of the interleaved subcarrier index sequence, f₁, f₂, f₃ and f₄ are four parameters of the 4-PP interleaver, and the parameter value rule is configured to determine the values of f₁, f₂, f₃ and f₄.

For example, in one embodiment of the present disclosure, the decomposition formula corresponding to the 4-PP interleaver is:

$$N = {Π}_{i = 1}^{ω ( N )} {p}_{i}^{{α}_{N , i}} \qquad ( 2 )$$

where ω(N) is a positive integer, pᵢ is a factor of N, and α_{N,i} is the corresponding exponent.

For example, in one embodiment of the present disclosure, the parameter value rule is:
when pᵢ=2 and α_{N,i}>1, the following condition must be met:

$${f}_{1} \neq 0 , ( {f}_{2} + {f}_{4} ) = 0 , {f}_{3} = 0 ( mod 2 ) \qquad ( 3 )$$

when 3ł(pᵢ−1), the following condition must be met:

$${f}_{1} \neq 0 , {f}_{2} = 0 , {f}_{3} = 0 , {f}_{4} = 0 ( mod {p}_{i} ) \qquad ( 4 )$$

For example, in one embodiment of the present disclosure, the allocating module is configured to:
decompose the N based on the decomposition formula to determine the values of pᵢ and α_{N,i};
determine the values of f₁, f₂, f₃ and f₄ based on the values of pᵢ and α_{N,i} and the parameter value rule; and
calculate the interleaved subcarrier index sequence based on the 4-PP interleaver function.

For example, in one embodiment of the present disclosure, the K subcarrier groups meet the following conditions:
in response to N being divisible by K, the numbers of subcarrier indexes contained in the K subcarrier groups are the same;
in response to N not being divisible by K, the numbers of subcarrier indexes contained in d subcarrier groups among the K subcarrier groups are the same, the numbers of subcarrier indexes contained in other subcarrier groups are the same, and the numbers of subcarrier indexes contained in the d subcarrier groups are 1 more than the numbers of subcarrier indexes contained in the other subcarrier groups, where d is the value of N modulo K.

For example, in one embodiment of the present disclosure, the frequency domain resources allocated to the same data receiving terminal under different symbols are the same or different.

For example, in one embodiment of the present disclosure, the determining module is configured to:
obtain the resource allocation scheme sent by the network device; and/or
determine the resource allocation scheme based on the protocol agreement by itself; and/or
determine the resource allocation scheme by itself.

For example, in one embodiment of the present disclosure, the determining module is configured to:
obtain the parameter configuration of the 4-PP interleaver sent by the network device; and/or
determine the parameter configuration of the 4-PP interleaver based on the protocol agreement.

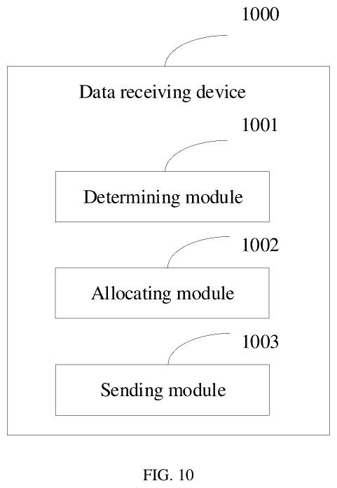

FIG. 10 is a structural schematic diagram of a data receiving device provided by an embodiment of the present disclosure. As shown in FIG. 10, the device includes:
a determining module 1001, configured to determine the resource allocation scheme as performing resource allocation based on a 4-PP interleaver;
an allocating module 1002, configured to allocate resources based on the resource allocation scheme; and
a sending module 1003, configured to send indication information, where the indication information is configured to determine the allocated resources.

In summary, in the device provided in the embodiment of the present disclosure, the resource allocation scheme is first determined as performing resource allocation based on a 4-PP interleaver; then, resources are allocated based on the resource allocation scheme, and indication information is sent, and the indication information is configured to determine the allocated resources. It can be seen that in the embodiment of the present disclosure, the 4-PP interleaver is introduced when allocating resources to the data receiving terminal, thereby avoiding the allocation of continuous frequency domain resources to the data receiving terminal, reducing the signal correlation between the subcarriers of the data receiving terminal, thereby ensuring the detection effect for the data receiving terminal, improving the detection performance of the ISAC system, and facilitating the detection of moving targets in the ISAC system.

For example, in one embodiment of the present disclosure, the allocating module is configured to:
obtain a subcarrier index sequence by sorting N subcarrier indexes in a symbol based on values of the N subcarrier indexes;
obtain an interleaved subcarrier index sequence by interleaving the subcarrier index sequence by a 4-PP interleaver;
obtain K subcarrier groups by grouping the interleaved subcarrier index sequence, where K is the number of data receiving terminals, and each subcarrier group includes at least one subcarrier index sequence;
allocate a subcarrier group to each of the K data receiving terminals, where a subcarrier corresponding to a subcarrier index in each subcarrier group is a frequency domain resource allocated to the data receiving terminal.

For example, in one embodiment of the present disclosure, the device is further configured to:
determine a parameter configuration of the 4-PP interleaver;
where the parameter configuration of the 4-PP interleaver includes at least one of the following:
a 4-PP interleaver function;
a decomposition formula corresponding to the 4-PP interleaver; and
a parameter value rule in the 4-PP interleaver function.

For example, in one embodiment of the present disclosure, the 4-PP interleaver function is:

$$π ( i ) = ( {f}_{1} \cdot i + {f}_{2} \cdot {i}^{2} + {f}_{3} \cdot {i}^{3} + {f}_{4} \cdot {i}^{4} ) mod N \qquad ( 1 )$$

wherein i indicates the i-th bit of the interleaved subcarrier index sequence, π(i) is the value of the i-th bit of the interleaved subcarrier index sequence, f₁, f₂, f₃ and f₄ are four parameters of the 4-PP interleaver, and the parameter value rule is configured to determine the values of f₁, f₂, f₃ and f₄.

For example, in one embodiment of the present disclosure, the decomposition formula corresponding to the 4-PP interleaver is:

$$N = {Π}_{i = 1}^{ω ( N )} {p}_{i}^{{α}_{N , i}} \qquad ( 2 )$$

where ω(N) is a positive integer, pᵢ is a factor of N, and α_{N,i} is the corresponding exponent.

For example, in one embodiment of the present disclosure, the parameter value rule is:
when pᵢ=2 and α_{N,i}>1, the following condition must be met:

$${f}_{1} \neq 0 , ( {f}_{2} + {f}_{4} ) = 0 , {f}_{3} = 0 ( mod 2 ) \qquad ( 3 )$$

when 3ł(pᵢ−1), the following condition must be met:

$${f}_{1} \neq 0 , {f}_{2} = 0 , {f}_{3} = 0 , {f}_{4} = 0 ( mod {p}_{i} ) \qquad ( 4 )$$

For example, in one embodiment of the present disclosure, the allocating module is configured to:
decompose the N based on the decomposition formula to determine the values of pᵢ and α_{N,i};
determine the values of f₁, f₂, f₃ and f₄ based on the values of pᵢ and α_{N,i} and the parameter value rule; and
calculate the interleaved subcarrier index sequence based on the 4-PP interleaver function.

For example, in one embodiment of the present disclosure, the K subcarrier groups meet the following conditions:
in response to N being divisible by K, the numbers of subcarrier indexes contained in the K subcarrier groups are the same;
in response to N not being divisible by K, the numbers of subcarrier indexes contained in d subcarrier groups among the K subcarrier groups are the same, the numbers of subcarrier indexes contained in other subcarrier groups are the same, and the numbers of subcarrier indexes contained in the d subcarrier groups are 1 more than the numbers of subcarrier indexes contained in the other subcarrier groups, where d is the value of N modulo K.

For example, in one embodiment of the present disclosure, the frequency domain resources allocated to the same data receiving terminal under different symbols are the same or different.

For example, in one embodiment of the present disclosure, the determining module is configured to:
obtain the resource allocation scheme sent by the network device; and/or
determine the resource allocation scheme based on the protocol agreement; and/or
determine the resource allocation scheme by itself.

For example, in one embodiment of the present disclosure, the determining module is configured to:
obtain the parameter configuration of the 4-PP interleaver sent by the network device; and/or
determine the parameter configuration of the 4-PP interleaver based on the protocol agreement.

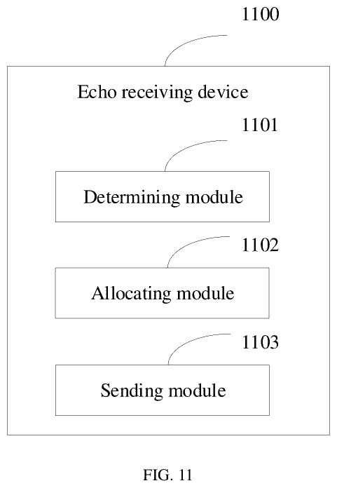

FIG. 11 is a structural schematic diagram of an echo receiving device provided by an embodiment of the present disclosure. As shown in FIG. 11, the device includes:
a determining module 1101, configured to determine the resource allocation scheme as performing resource allocation based on a 4-PP interleaver;
an allocating module 1102, configured to allocate resources based on the resource allocation scheme;
a sending module 1103, configured to send indication information, where the indication information is configured to determine the allocated resources.

In summary, in the device provided in the embodiment of the present disclosure, the resource allocation scheme is first determined as performing resource allocation based on a 4-PP interleaver; then, resources are allocated based on the resource allocation scheme, and indication information is sent, and the indication information is configured to determine the allocated resources. It can be seen that in the embodiment of the present disclosure, the 4-PP interleaver is introduced when allocating resources to the data receiving terminal, thereby avoiding the allocation of continuous frequency domain resources to the data receiving terminal, reducing the signal correlation between the subcarriers of the data receiving terminal, thereby ensuring the detection effect for the data receiving terminal, improving the detection performance of the ISAC system, and facilitating the detection of moving targets in the ISAC system.

For example, in one embodiment of the present disclosure, the allocating module is configured to:
obtain a subcarrier index sequence by sorting N subcarrier indexes in a symbol based on values of the N subcarrier indexes;
obtain an interleaved subcarrier index sequence by interleaving the subcarrier index sequence by the 4-PP interleaver;
obtain K subcarrier groups by grouping the interleaved subcarrier index sequence, where K is the number of data receiving terminals, and each subcarrier group includes at least one subcarrier index sequence;
allocate a subcarrier group to each of the K data receiving terminals, where a subcarrier corresponding to a subcarrier index in each subcarrier group is a frequency domain resource allocated to the data receiving terminal.

For example, in one embodiment of the present disclosure, the device is further configured to:
determine a parameter configuration of the 4-PP interleaver;
where the parameter configuration of the 4-PP interleaver includes at least one of the following:
a 4-PP interleaver function;
a decomposition formula corresponding to the 4-PP interleaver; and
a parameter value rule in the 4-PP interleaver function.

For example, in one embodiment of the present disclosure, the 4-PP interleaver function is:

$$π ( i ) = ( {f}_{1} \cdot i + {f}_{2} \cdot {i}^{2} + {f}_{3} \cdot {i}^{3} + {f}_{4} \cdot {i}^{4} ) mod N \qquad ( 1 )$$

where i indicates the i-th bit of the interleaved subcarrier index sequence, π(i) is the value of the i-th bit of the interleaved subcarrier index sequence, f₁, f₂, f₃ and f₄ are four parameters of the 4-PP interleaver, and the parameter value rule is configured to determine the values of f₁, f₂, f₃ and f₄.

For example, in one embodiment of the present disclosure, the decomposition formula corresponding to the 4-PP interleaver is:

$$N = {\prod }_{i = 1}^{ω ( N )} {p}_{i}^{{α}_{N , i}} \qquad ( 2 )$$

where ω(N) is a positive integer, pᵢ is a factor of N, and α_{N,i} is the corresponding exponent.

For example, in one embodiment of the present disclosure, the parameter value rule is:
when pᵢ=2 and α_{N,i}>1, the following condition must be met:

$${f}_{1} \neq 0 , ( {f}_{2} + {f}_{4} ) = 0 , {f}_{3} = 0 ( mod 2 ) \qquad ( 3 )$$

when 3ł(pᵢ−1), the following condition must be met:

$${f}_{1} \neq 0 , {f}_{2} = 0 , {f}_{3} = 0 , {f}_{4} = 0 ( mod {p}_{i} ) \qquad ( 4 )$$

For example, in one embodiment of the present disclosure, the allocating module is configured to:
decompose the N based on the decomposition formula to determine the values of pᵢ and α_{N,i};
determine the values of f₁, f₂, f₃ and f₄ based on the values of pᵢ and α_{N,i} and the parameter value rule; and
calculate the interleaved subcarrier index sequence based on the 4-PP interleaver function.

For example, in one embodiment of the present disclosure, the K subcarrier groups meet the following conditions:
in response to N being divisible by K, the numbers of subcarrier indexes contained in the K subcarrier groups are the same;
in response to N not being divisible by K, the numbers of subcarrier indexes contained in d subcarrier groups among the K subcarrier groups are the same, the numbers of subcarrier indexes contained in other subcarrier groups are the same, and the numbers of subcarrier indexes contained in the d subcarrier groups are 1 more than the numbers of subcarrier indexes contained in the other subcarrier groups, where d is the value of N modulo K.

For example, in one embodiment of the present disclosure, the frequency domain resources allocated to the same data receiving terminal under different symbols are the same or different.

For example, in one embodiment of the present disclosure, the determining module is configured to:
obtain the resource allocation scheme sent by the network device; and/or
determine the resource allocation scheme based on the protocol agreement; and/or
determine the resource allocation scheme by itself.

For example, in one embodiment of the present disclosure, the determining module is configured to:
obtain the parameter configuration of the 4-PP interleaver sent by the network device; and/or
determine the parameter configuration of the 4-PP interleaver based on the protocol agreement.

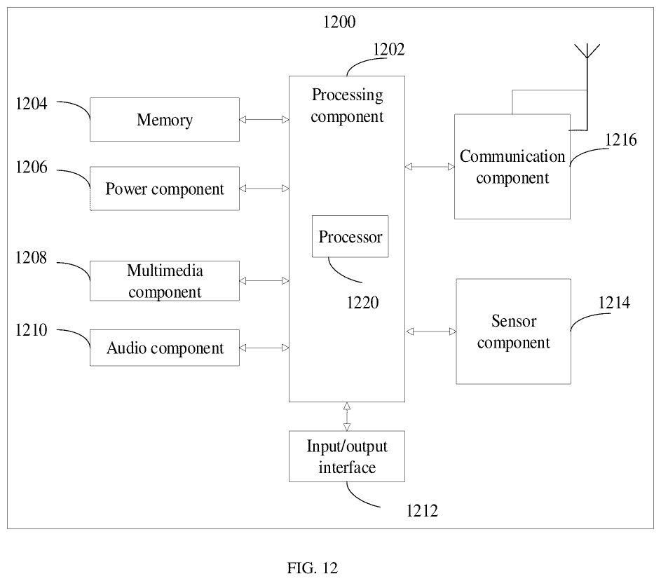

FIG. 12 is a block diagram of a user equipment UE 1200 provided in one embodiment of the present disclosure. For example, UE 1200 can be a mobile phone, a computer, a digital broadcast terminal device, a message transceiver device, a game console, a tablet device, a medical device, a fitness device, a personal digital assistant, etc.

Referring to FIG. 12, UE 1200 may include at least one of the following components: a processing component 1202, a memory 1204, a power component 1206, a multimedia component 1208, an audio component 1210, an input/output (I/O) interface 1212, a sensor component 1213, and a communication component 1216.

The processing component 1202 generally controls the overall operation of the UE 1200, such as operations associated with display, phone calls, data communications, camera operations, and recording operations. The processing component 1202 may include at least one processor 1220 to execute instructions to complete all or part of the steps of the above-mentioned method. In addition, the processing component 1202 may include at least one module to facilitate interaction between the processing component 1202 and other components. For example, the processing component 1202 may include a multimedia module to facilitate interaction between the multimedia component 1208 and the processing component 1202.

The memory 1204 is configured to store various types of data to support operations in the UE 1200. Examples of such data include instructions for any application or method operating on UE1200, contact data, phonebook data, messages, pictures, videos, etc. Memory 1204 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

Power component 1206 provides power to various components of UE 1200. Power component 1206 may include a power management system, at least one power supply, and other components associated with generating, managing and distributing power for UE 1200.

Multimedia component 1208 includes a screen that provides an output interface between the UE 1200 and the user. In some embodiments, the screen may include a liquid crystal display (LCD) and a touch panel (TP). If the screen includes a touch panel, the screen may be implemented as a touch screen to receive input signals from the user. The touch panel includes at least one touch sensor to sense touch, slide, and gestures on the touch panel. The touch sensor can not only sense the boundary of the touch or slide action, but also detect the wake-up time and pressure associated with the touch or slide operation. In some embodiments, the multimedia component 1208 includes a front camera and/or a rear camera. When UE 1200 is in an operating mode, such as a shooting mode or a video mode, the front camera and/or the rear camera can receive external multimedia data. Each front camera and rear camera can be a fixed optical lens system or have focal length and optical zoom capabilities.

The audio component 1210 is configured to output and/or input audio signals. For example, the audio component 1210 includes a microphone (MIC). When UE 1200 is in an operating mode, such as a call mode, a recording mode, and a voice recognition mode, the microphone is configured to receive an external audio signal. The received audio signal can be further stored in the memory 1204 or sent via the communication component 1216. In some embodiments, the audio component 1210 further includes a speaker for outputting an audio signal.

The I/O interface 1212 provides an interface between the processing component 1202 and the peripheral interface module. The peripheral interface module may be a keyboard, a click wheel, buttons, etc. These buttons may include, but are not limited to, a home button, a volume button, a start button, and a lock button.

The sensor component 1213 includes at least one sensor for providing various aspects of status assessment for the UE 1200. For example, the sensor component 1213 may detect the open/closed state of the device 1200, and the relative positioning of components, such as the display and keypad of the UE 1200. The sensor component 1213 may further detect the position change of the UE 1200 or a component of the UE 1200, the presence or absence of user contact with the UE 1200, the orientation or acceleration/deceleration of the UE 1200, and the temperature change of the UE 1200. The sensor component 1213 may include a proximity sensor configured to detect the presence of a nearby object without any physical contact. The sensor component 1213 may further include a light sensor, such as a CMOS or CCD image sensor, for use in imaging applications. In some embodiments, the sensor component 1213 may further include an acceleration sensor, a gyroscope sensor, a magnetic sensor, a pressure sensor or a temperature sensor.

The communication component 1216 is configured to facilitate wired or wireless communication between UE 1200 and other devices. UE 1200 can access a wireless network based on a communication standard, such as WiFi, 2G or 3G, or a combination thereof. In an example embodiment, the communication component 1216 receives a broadcast signal or broadcast-related information from an external broadcast management system via a broadcast channel. In an example embodiment, the communication component 1216 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In an example embodiment, UE 1200 may be implemented by at least one application-specific integrated circuit (ASIC), digital signal processor (DSP), digital signal processing device (DSPD), programmable logic device (PLD), field programmable gate array (FPGA), controller, microcontroller, microprocessor or other electronic component to perform the above method.

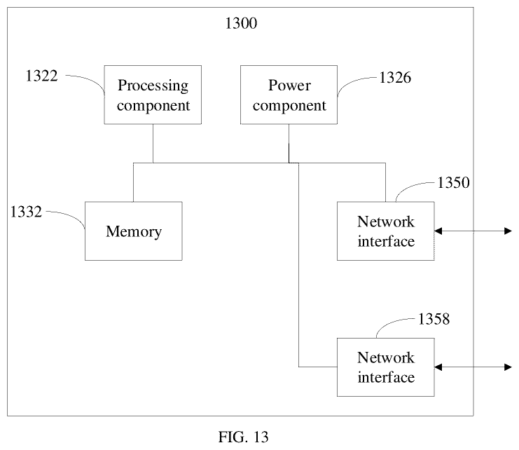

FIG. 13 is a block diagram of a network side device 1300 provided in an embodiment of the present disclosure. For example, the network side device 1300 may be provided as a network side device. Referring to FIG. 13, the network side device 1300 includes a processing component 1311, which further includes at least one processor, and a memory resource represented by a memory 1332 for storing instructions executable by the processing component 1322, such as an application. The application stored in the memory 1332 may include one or more modules, each of which corresponds to a set of instructions. In addition, the processing component 1310 is configured to execute instructions to execute any method of the above method applied to the network side device, for example, the method shown in FIG. 1.

The network side device 1300 may further include a power component 1326 configured to perform power management of the network side device 1300, a wired or wireless network interface 1350 configured to connect the network side device 1300 to the network, and an input/output (I/O) interface 1358. The network side device 1300 may operate based on an operating system stored in the memory 1332, such as Windows Server™, Mac OS X™, Unix™, Linux™, Free BSD™ or the like.

In the above embodiments provided by the present disclosure, the methods provided by the embodiments of the present disclosure are described from the perspectives of the network side device and the UE, respectively. In order to implement the functions of the methods provided by the above embodiments of the present disclosure, the network side device and the UE may include a hardware structure and a software module, and implement the above functions in the form of a hardware structure, a software module, or a hardware structure plus a software module. One of the above functions may be executed in the form of a hardware structure, a software module, or a hardware structure plus a software module.

In the above embodiments provided by the present disclosure, the methods provided by the embodiments of the present disclosure are described from the perspectives of the network side device and the UE, respectively. In order to implement the functions of the method provided in the above embodiment of the present disclosure, the network side device and the UE may include a hardware structure and a software module, and implement the above functions in the form of a hardware structure, a software module, or a hardware structure plus a software module. One of the above functions may be executed in the form of a hardware structure, a software module, or a hardware structure plus a software module.

A communication device is provided in the embodiment of the present disclosure. The communication device may include a transceiver module and a processing module. The transceiver module may include a sending module and/or a receiving module. The sending module is configured to implement the sending function, the receiving module is configured to implement the receiving function, and the transceiver module may implement the sending function and/or the receiving function.

The communication device may be a terminal device (such as the terminal device in the above method embodiment), or a device in the terminal device, or a device that can be used in combination with the terminal device. Alternatively, the communication device may be a network device, or a device in the network device, or a device that can be used in combination with the network device.

Another communication device is provided in the embodiment of the present disclosure. The communication device may be a network device, or a terminal device (such as the terminal device in the above method embodiment), or a chip, a chip system, or a processor etc. that supports the network device to implement the above method, or a chip, a chip system, or a processor etc. that supports the terminal device to implement the above method. The device may be configured to implement the method described in the above method embodiment, and the details may refer to the description in the above method embodiment.

The communication device may include one or more processors. The processor may be a general-purpose processor or a dedicated processor, etc. For example, it may be a baseband processor or a central processor. The baseband processor may be configured to process the communication protocol and communication data, and the central processor may be configured to control the communication device (such as a network side device, a baseband chip, a terminal device, a terminal device chip, a DU or a CU, etc.), execute a computer program, and process the data of the computer program.

For example, the communication device may further include one or more memories, on which a computer program may be stored, and the processor executes the computer program so that the communication device executes the method described in the above method embodiment. For example, data may also be stored in the memory. The communication device and the memory may be provided separately or integrated together.

For example, the communication device may further include a transceiver and an antenna. The transceiver may be referred to as a transceiver unit, a transceiver, or a transceiver circuit, etc., for implementing the transceiver function. The transceiver may include a receiver and a transmitter. The receiver may be referred to as a receiver or a receiving circuit, etc., for implementing the receiving function. The transmitter may be referred to as a transmitter or a transmitting circuit, etc., for implementing the transmitting function.

For example, the communication device may further include one or more interface circuits. The interface circuit is configured to receive code instructions and transmit them to the processor. The processor runs the code instructions to enable the communication device to perform the method described in the above method embodiment.

In one implementation, the processor may include a transceiver for implementing the receiving and transmitting functions. For example, the transceiver may be a transceiver circuit, or an interface, or an interface circuit. The transceiver circuit, interface, or interface circuit for implementing the receiving and transmitting functions may be separate or integrated. The above transceiver circuit, interface, or interface circuit may be used for reading and writing code/data, or the above transceiver circuit, interface, or interface circuit may be used for signal transmission or delivery.

In one implementation, the processor may store a computer program, and the computer program runs on the processor, so that the communication device can perform the method described in the above method embodiment. The computer program may be embedded in the processor, in which case the processor may be implemented by hardware.

In one implementation, the communication device may include a circuit, which can implement the functions of sending or receiving or communicating in the above method embodiment. The processor and transceiver described in the present disclosure can be implemented in an integrated circuit (IC), an analog IC, a radio frequency integrated circuit RFIC, a mixed signal IC, an application specific integrated circuit (ASIC), a printed circuit board (PCB), an electronic device, etc. The processor and transceiver can also be manufactured using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device described in the above embodiments may be a network device or a terminal device (such as the terminal device in the above method embodiment), but the scope of the communication device described in the present disclosure is not limited thereto, and the structure of the communication device may not be limited thereto. The communication device may be an independent device or may be part of a larger device. For example, the communication device may be:
(1) an independent integrated circuit IC, or a chip, or a chip system or subsystem;
(2) a collection of one or more ICs, for example, the IC collection may further include a storage component for storing data or computer programs;
(3) an ASIC, such as a modem;
(4) a module that can be embedded in other devices;
(5) a receiver, a terminal device, an intelligent terminal device, a cellular phone, a wireless device, a handheld device, a mobile unit, a vehicle-mounted device, a network device, a cloud device, an artificial intelligence device, etc.;
(6) others, etc.

In the case where the communication device may be a chip or a chip system, the chip includes a processor and an interface. The number of processors may be one or more, and the number of interfaces may be multiple.

For example, the chip further includes a memory, and the memory is configured to store necessary computer programs and data.

Those skilled in the art may also understand that the various illustrative logical blocks and steps listed in the embodiments of the present disclosure may be implemented by electronic hardware, computer software, or a combination of the two. Whether such functions are implemented by hardware or software depends on the specific application and the design requirements of the entire system. Those skilled in the art may use various methods to implement the functions described for each specific application, but such implementation should not be understood as going beyond the scope of protection of the embodiments of the present disclosure.

The present disclosure also provides a readable storage medium on which instructions are stored, and when the instructions are executed by a computer, the functions of any of the above method embodiments are implemented.

The present disclosure also provides a computer program product, which, when executed by a computer, implements the functions of any of the above method embodiments.

In the above embodiments, it can be implemented in whole or in part by software, hardware, firmware, or any combination thereof. When implemented by software, it can be implemented in whole or in part in the form of a computer program product. The computer program product includes one or more computer programs. When the computer program is loaded and executed on a computer, the process or function described in the embodiments of the present disclosure is generated in whole or in part. The computer may be a general-purpose computer, a special-purpose computer, a computer network, or other programmable device. The computer program may be stored in a computer-readable storage medium, or transmitted from one computer-readable storage medium to another computer-readable storage medium. For example, the computer program may be transmitted from one website, computer, server or data center to another website, computer, server or data center by wired (e.g., coaxial cable, optical fiber, digital subscriber line (DSL)) or wireless (e.g., infrared, wireless, microwave, etc.) means. The computer-readable storage medium may be any available medium that can be accessed by a computer or a data storage device such as a server or data center that includes one or more available media integrated therein. The available medium may be a magnetic medium (e.g., a floppy disk, a hard disk, a tape), an optical medium (e.g., a high-density digital video disc (DVD)), or a semiconductor medium (e.g., a solid state disk (SSD)), etc.

Those skilled in the art may understand that the various digital numbers such as the first and second involved in the present disclosure are only used for the convenience of description, and are not used to limit the scope of the embodiments of the present disclosure, and also indicate the order of precedence.

The expression of “at least one” in the present disclosure may also be described as one or more, and “more” may be two, three, four or more, which is not limited by the present disclosure. In the embodiments of the present disclosure, for a technical feature, different elements in the technical feature are distinguished by “first”, “second”, “third”, “A”, “B”, “C” and “D”, etc., and there is no order of precedence or order of magnitude between the elements described by the “first”, “second”, “third”, “A”, “B”, “C” and “D”.

After considering the specification and practicing the present disclosure, it will be easy for those skilled in the art to think of other embodiments of the present disclosure. The present disclosure is intended to cover any variation, use or adaptive change of the present disclosure, which follows the general principles of the present disclosure and includes common knowledge or customary technical means in the art not disclosed in the present disclosure. The description and embodiments are to be regarded as examples only, and the true scope and spirit of the present disclosure are indicated by the following claims.

It should be understood that the present disclosure is not limited to the precise structure described above and shown in the drawings, and various modifications and changes can be made without departing from its scope. The scope of the present disclosure is limited only by the appended claims.

1. A resource allocation method, comprising:
determining a resource allocation scheme as performing resource allocation based on a Quartic Permutation Polynomial (4-PP) interleaver;
allocating a resource based on the resource allocation scheme; and
sending indication information, wherein the indication information is configured to determine the allocated resource.

2. The method according to claim 1, wherein allocating the resource based on the resource allocation scheme comprises:
obtaining a subcarrier index sequence by sorting N subcarrier indexes in a symbol based on values of the N subcarrier indexes;
obtaining an interleaved subcarrier index sequence by interleaving the subcarrier index sequence by the 4-PP interleaver;
obtaining K subcarrier groups by grouping the interleaved subcarrier index sequence, wherein K is a number of data receiving terminals, and each subcarrier group comprises at least one subcarrier index sequence; and
allocating a subcarrier group to each of the K data receiving terminals, wherein a subcarrier corresponding to a subcarrier index in each subcarrier group is a frequency domain resource allocated to the data receiving terminal.

3. The method according to claim 2, further comprising:
determining a parameter configuration of the 4-PP interleaver;
wherein the parameter configuration of the 4-PP interleaver comprises at least one of:
a 4-PP interleaver function;
a decomposition formula corresponding to the 4-PP interleaver; and
a parameter value rule in the 4-PP interleaver function.

4. The method according to claim 3, wherein the 4-PP interleaver function is:
$$π ( i ) = ( {f}_{1} \cdot i + {f}_{2} \cdot {i}^{2} + {f}_{3} \cdot {i}^{3} + {f}_{4} \cdot {i}^{4} ) mod N ;$$
wherein i indicates a i-th bit of the interleaved subcarrier index sequence, π(i) is a value of the i-th bit of the interleaved subcarrier index sequence, f₁, f₂, f₃ and f₄ are four parameters of the 4-PP interleaver, and the parameter value rule is configured to determine values of f₁, f₂, f₃ and f₄.

5. The method according to claim 3, wherein the decomposition formula corresponding to the 4-PP interleaver is:
$$N = {\prod }_{i = 1}^{ω ( N )} {p}_{i}^{{α}_{N , i}} ;$$
wherein ω(N) is a positive integer, pᵢ is a factor of N, and α_{N,i} is a corresponding exponent.

6. The method according to claim 3, wherein the 4-PP interleaver function is:
$$π ( i ) = ( {f}_{1} \cdot i + {f}_{2} \cdot {i}^{2} + {f}_{3} \cdot {i}^{3} + {f}_{4} \cdot {i}^{4} ) mod N ;$$
wherein i indicates a i-th bit of the interleaved subcarrier index sequence, π(i) is a value of the i-th bit of the interleaved subcarrier index sequence, f₁, f₂, f₃ and f₄ are four parameters of the 4-PP interleaver, and the parameter value rule is configured to determine values of f₁, f₂, f₃ and f₄;
the decomposition formula corresponding to the 4-PP interleaver is:
$$N = {\prod }_{i = 1}^{ω ( N )} {p}_{i}^{{α}_{N , i}} ;$$
wherein ω(N) is a positive integer, pᵢ is a factor of N, and α_{N,i} is a corresponding exponent, and
wherein the parameter value rule is:
in response to determining pᵢ=2 and α_{N,i}>1, meeting a following condition:
$${f}_{1} \neq 0 , ( {f}_{2} + {f}_{4} ) = 0 , {f}_{3} = 0 ( mod 2 ) ;$$
or
in response to determining 3 ł(pᵢ−1), meeting a following condition:
$${f}_{1} \neq 0 , {f}_{2} = 0 , {f}_{3} = 0 , {f}_{4} = 0 ( mod {p}_{i} ) .$$

7. The method according to claim 3, wherein interleaving the subcarrier index sequence by the 4-PP interleaver comprises:
determining values of pᵢ and α_{N,i} by decomposing the N based on the decomposition formula;
determining the values of f₁, f₂, f₃ and f₄ based on the values of pᵢ and α_{N,i} and the parameter value rule; and
calculating the interleaved subcarrier index sequence based on the 4-PP interleaver function.

8. The method according to claim 2, wherein the K subcarrier groups meet following conditions:
in response to N being divisible by K, numbers of subcarrier indexes contained in the K subcarrier groups are same;
in response to N not being divisible by K, numbers of subcarrier indexes contained in d subcarrier groups among the K subcarrier groups are same, numbers of subcarrier indexes contained in other subcarrier groups are same, and the numbers of subcarrier indexes contained in the d subcarrier groups are 1 more than the numbers of subcarrier indexes contained in the other subcarrier groups, wherein d is a value of N modulo K.

9. The method according to claim 2, wherein frequency domain resources allocated to a same data receiving terminal under different symbols are same or different.

10. The method according to claim 1, wherein determining the resource allocation scheme comprises at least one of:
obtaining the resource allocation scheme sent by a network device;
determining the resource allocation scheme based on a protocol agreement; and
determining the resource allocation scheme by itself.

11. The method according to claim 3, wherein determining the parameter configuration of the 4-PP interleaver comprises at least one of:
obtaining the parameter configuration of the 4-PP interleaver sent by a network device; and
determining the parameter configuration of the 4-PP interleaver based on a protocol agreement.

12.-14. (canceled)

15. A communication device, comprising:
a processor; and
a memory storing a computer program executable by the processor;
wherein the processor is configured to:
determine a resource allocation scheme as performing resource allocation based on a Quartic Permutation Polynomial (4-PP) interleaver;
allocate a resource based on the resource allocation scheme; and
send indication information, wherein the indication information is configured to determine the allocated resource.

16. A communication device, comprising:
a processor; and
an interface circuit, wherein
the interface circuit is configured to receive code instructions and transmit them to the processor; and
the processor is configured to run the code instructions to:
determine a resource allocation scheme as performing resource allocation based on a Quartic Permutation Polynomial (4-PP) interleaver;
allocate a resource based on the resource allocation scheme; and
send indication information, wherein the indication information is configured to determine the allocated resource.

17. A non-transitory computer-readable storage medium for storing instructions that, when being executed by a processor, cause the processor to perform the method according to claim 1.

18. The communication device according to claim 15, wherein the processor is further configured to:
obtain a subcarrier index sequence by sorting N subcarrier indexes in a symbol based on values of the N subcarrier indexes;
obtain an interleaved subcarrier index sequence by interleaving the subcarrier index sequence by the 4-PP interleaver;
obtain K subcarrier groups by grouping the interleaved subcarrier index sequence, wherein K is a number of data receiving terminals, and each subcarrier group comprises at least one subcarrier index sequence; and
allocate a subcarrier group to each of the K data receiving terminals, wherein a subcarrier corresponding to a subcarrier index in each subcarrier group is a frequency domain resource allocated to the data receiving terminal.

19. The communication device according to claim 18, wherein the processor is further configured to:
determine a parameter configuration of the 4-PP interleaver;
wherein the parameter configuration of the 4-PP interleaver comprises at least one of:
a 4-PP interleaver function;
a decomposition formula corresponding to the 4-PP interleaver; and
a parameter value rule in the 4-PP interleaver function.

20. The communication device according to claim 19, wherein the 4-PP interleaver function is:
$$π ( i ) = ( {f}_{1} \cdot i + {f}_{2} \cdot {i}^{2} + {f}_{3} \cdot {i}^{3} + {f}_{4} \cdot {i}^{4} ) mod N ;$$
wherein i indicates a i-th bit of the interleaved subcarrier index sequence, π(i) is a value of the i-th bit of the interleaved subcarrier index sequence, f₁, f₂, f₃ and f₄ are four parameters of the 4-PP interleaver, and the parameter value rule is configured to determine values of f₁, f₂, f₃ and f₄.

21. The communication device according to claim 19, wherein the decomposition formula corresponding to the 4-PP interleaver is:
$$N = {\prod }_{i = 1}^{ω ( N )} {p}_{i}^{{α}_{N , i}} ;$$
wherein ω(N) is a positive integer, pᵢ is a factor of N, and α_{N,i} is a corresponding exponent.

22. The communication device according to claim 19, wherein the 4-PP interleaver function is:
$$π ( i ) = ( {f}_{1} \cdot i + {f}_{2} \cdot {i}^{2} + {f}_{3} \cdot {i}^{3} + {f}_{4} \cdot {i}^{4} ) mod N ;$$
wherein i indicates a i-th bit of the interleaved subcarrier index sequence, π(i) is a value of the i-th bit of the interleaved subcarrier index sequence, f₁, f₂, f₃ and f₄ are four parameters of the 4-PP interleaver, and the parameter value rule is configured to determine values of f₁, f₂, f₃ and f₄;
the decomposition formula corresponding to the 4-PP interleaver is:
$$N = {\prod }_{i = 1}^{ω ( N )} {p}_{i}^{{α}_{N , i}} ;$$
wherein ω(N) is a positive integer, pᵢ is a factor of N, and α_{N,i} is a corresponding exponent, and
wherein the parameter value rule is:
in response to determining pᵢ=2 and α_{N,i}>1, meeting a following condition:
$${f}_{1} \neq 0 , ( {f}_{2} + {f}_{4} ) = 0 , {f}_{3} = 0 ( mod 2 ) ;$$
or
in response to determining that 3ł(pᵢ−1), meeting a following condition:
$${f}_{1} \neq 0 , {f}_{2} = 0 , {f}_{3} = 0 , {f}_{4} = 0 ( mod {p}_{i} ) .$$

23. The communication device according to claim 18, wherein the K subcarrier groups meet following conditions:
in response to N being divisible by K, numbers of subcarrier indexes contained in the K subcarrier groups are same;
in response to N not being divisible by K, numbers of subcarrier indexes contained in d subcarrier groups among the K subcarrier groups are same, numbers of subcarrier indexes contained in other subcarrier groups are same, and the numbers of subcarrier indexes contained in the d subcarrier groups are 1 more than the numbers of subcarrier indexes contained in the other subcarrier groups, wherein d is a value of N modulo K.
